(19) United States
(12) Patent Application Publication
(10) Pub. No.: US 2007/0046857 A1
(43) Pub. Date: Mar. 1, 2007

(54) LIQUID CRYSTAL DISPLAY

(75) Inventor: Hiroyuki MURAI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/419,381

(22) Filed: May 19, 2006

(30) Foreign Application Priority Data
Aug. 29, 2005 (JP) 2005-247063

(51) Int. Cl. G02F 1/1335

(52) U.S. Cl. 349/62; 349/69; 428/1.1; 428/690; 428/917

(57) ABSTRACT

A liquid crystal display includes an organic EL backlight, a liquid crystal panel, a linear polarization reflector and an absorber spaced in parallel to each other. The particular arrangement is such that the organic EL backlight is held between the liquid crystal panel and the linear polarization reflector, and the linear polarization reflector is held between the organic EL backlight and the absorber. The organic EL backlight has a transparent substrate, a transparent electrode as an anode formed on the front surface of the transparent substrate, an organic EL layer and a transparent electrode as a cathode stacked in this order. The organic EL layer has an organic light emitting layer containing an organic EL material for generating emission of phosphorescence with an emission lifetime of 100 nsec to 1 msec.

### BACKGROUND OF THE INVENTION

1. Field of the Invention

The present invention relates to a liquid crystal display and more particularly, relates to a liquid crystal display using an organic EL (electroluminescence) backlight.

2. Description of the Background Art

Japanese Patent Application Laid-Open No. 9-50031 (1997, FIG. 1) discloses a known structure of a liquid crystal display using a conventional organic EL backlight.

According to the structure disclosed in this publication, a transparent electrode, an organic EL layer and a reflective electrode are stacked in this order on the rear surface (the surface opposite to a liquid crystal panel) of a transparent substrate to form an organic EL backlight.

The transparent substrate, the transparent electrode as an anode, and the reflective electrode as a cathode are respectively formed by glass, ITO (indium tin oxide) that is a conductive transparent material, and a metallic material.

The organic EL layer includes a hole transport layer, an organic light emitting layer and an electron transport layer. When a positive voltage and a negative voltage are respectively applied to the anode and the cathode, electrons injected through the electron transport layer into the organic light emitting layer and holes injected through the hole transport layer into the organic light emitting layer are recombined in the organic light emitting layer to generate fluorescence therein.

The light thereby generated in the organic light emitting layer passes through the transparent anode and the transparent substrate, and is thereafter emitted from the front surface (the surface facing the liquid crystal panel) of the organic EL backlight.

Light emitted from the organic EL layer is spontaneously emitted light, and therefore is subjected to no deviation of polarization. This light contains two linearly polarized light components orthogonal to each other in the same ratio, or contains a right-handed circularly polarized light component and a left-handed circularly polarized light component in the same ratio. Further, this spontaneously emitted light travels in all directions.

With regard to light entering the liquid crystal panel, as a result of the existence of a polarizing plate provided on the side of the backlight, a light component in one polarization direction passes through the liquid crystal panel whereas a light component in the other polarization direction is absorbed.

As discussed, in the liquid crystal display using the conventional organic EL backlight, light emitted from the organic EL layer is subjected to no deviation of polarization. That is, in principle, half the light emitted from the organic EL backlight is allowed to enter the liquid crystal panel to be used therein. Thus the liquid crystal display using the conventional organic EL backlight suffers from low efficiency of use of light emitted from the organic EL backlight.

### SUMMARY OF THE INVENTION

It is an object of the present invention to provide a liquid crystal display with increased efficiency of use of light emitted from an EL backlight.

According to the present invention, the liquid crystal display includes an EL backlight having an EL layer for generating EL (electroluminescence) emission, a liquid crystal panel arranged on the side of a front surface of the EL backlight, and a polarization reflector arranged on the side of the front surface or a rear surface of the EL backlight. The polarization reflector selectively reflects light as one of two polarized light components of light generated at the EL backlight to allow the light as one of the two polarized light components to return to the EL backlight. The EL layer contains an EL material for generating emission of phosphorescence with an emission lifetime of 100 nsec to 1 msec.

This liquid crystal display includes a polarization reflector for selectively reflects light as one of two polarized light components of light generated at the EL backlight to allow the light as one of the two polarized light components to return to the EL backlight. The light returning to the EL backlight generates emission of phosphorescence to thereby generate stimulated emission in the EL layer with a high degree of efficiency. Thus light can be limited to a polarization component entering the liquid crystal panel, and the intensity of light can be amplified by the stimulated emission. As a result, an increased efficiency of use of light emitted from the EL backlight is realized to increase the amount of light entering the liquid crystal panel. Thus a high-brightness liquid crystal display is realized. Further, the EL layer contains an EL material for generating emission of phosphorescence with an emission lifetime of 100 nsec to 1 msec, so photons meet molecules of the EL material in an excited state with a high probability. Thus stimulated emission is generated with a high degree of efficiency while the deterioration of the EL material due to the reaction of the EL material with oxygen or water is suppressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view schematically showing the basic structure of a liquid crystal display according to a first preferred embodiment of the present invention;

FIG. 2 is a sectional view schematically showing the basic structure of a liquid crystal display according to a second preferred embodiment of the present invention;

FIG. 3 is a sectional view schematically showing the basic structure of a liquid crystal display according to a third preferred embodiment of the present invention;

FIG. 4 is a sectional view schematically showing the basic structure of a liquid crystal display according to a first modification of the third preferred embodiment;

FIG. 5 is a sectional view schematically showing the basic structure of a liquid crystal display according to a second modification of the third preferred embodiment;

FIG. 6 is a sectional view schematically showing the basic structure of a liquid crystal display according to a fourth preferred embodiment of the present invention;

FIG. 7 is a sectional view schematically showing the basic structure of a liquid crystal display according to a first modification of the fourth preferred embodiment; and

FIG. 8 is a sectional view schematically showing the basic structure of a liquid crystal display according to a second modificdation of the fourth preferred embodiment.

### DESCRIPTION OF THE PREFERRED EMBODIMENTS

### A. First Preferred Embodiment

A-1. Device Structure

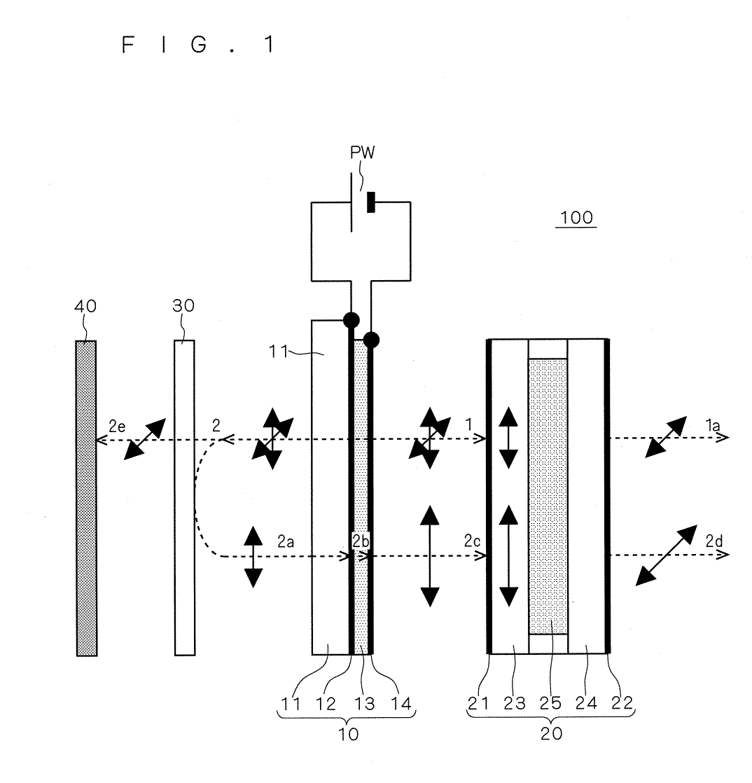

FIG. 1 is a sectional view schematically showing the basic structure of a liquid crystal display 100 according to a first preferred embodiment of the present invention.

With reference to FIG. 1, the liquid crystal display 100 includes an organic EL backlight 10, a liquid crystal panel 20, a linear polarization reflector 30 and an absorber 40 spaced in parallel to each other. The particular arrangement is such that the organic EL backlight 10 is held between the liquid crystal panel 20 and the linear polarization reflector 30, and the linear polarization reflector 30 is held between the organic EL backlight 10 and the absorber 40. In the following, with respect to the organic EL backlight 10, the side on which the liquid crystal panel 20 is arranged is referred to as a front side and its opposite side is referred to as a rear side.

The organic EL backlight 10 has a transparent substrate 11, a transparent electrode 12 as an anode formed on the front surface (surface facing the liquid crystal panel 20) of the transparent substrate 11, an organic EL layer 13 and a transparent electrode 14 as a cathode stacked in this order. The organic EL layer 13 faces the liquid crystal panel 20. The transparent electrodes 12 and 14 are connected to a power supply PW.

The transparent substrate 11 may be formed by glass, for example. Alternatively, the transparent substrate 11 may be formed by a resin film or a resin sheet containing polymethyl methacrylate, polycarbonate, polystyrene, styrene acrylonitrile, cycloolefin, alicyclic polyolefin, cyclic polyolefin, alicyclic acrylic, polyester, or the like.

The organic EL layer 13 may be formed by a hole transport layer, an organic light emitting layer and an electron transport layer. Alternatively, the organic EL layer 13 may be formed by a hole transport layer, an organic light emitting layer, a hole leakage blocking layer, an electron transport layer and an electron injection layer. Still alternatively, the organic EL layer 13 may be formed by a hole injection layer, a hole transport layer, an organic light emitting layer, a hole leakage blocking layer, an electron transport layer and an electron injection layer.

As an example, the hole injection layer, hole transport layer, hole leakage blocking layer for preventing leakage of holes, electron transport layer and electron injection layer may respectively contain CuPc, α-NPD, BCP, Alq₃ (aluminato-tris-8-hydroxyquinolate), and Lif.

As a host material for the organic light emitting layer, CBP as a carbazole derivative, or a carbazole derivative compound formed on the basis of CBP may be used, for example.

An organic EL material for generating emission of phosphorescence with an emission lifetime of 100 nsec to 1 msec is used at least as one of components of the organic light emitting layer, whereby the organic light emitting layer is allowed to emit phosphorescence.

As a specific example, an iridium metal complex such as FIr (pic), Ir (ppy)₃ or Btp₂Ir (acac) as a dopant for phosphorescence emission into the host material for the organic light emitting layer.

The organic light emitting layer is formed by the co-deposition of the host material and the dopant. At this time, the ratio of components is preferably controlled such that the deposited host material and the deposited dopant respectively make up 80 to 99.5 percent by mass and 0.5 to 20 percent by mass in the organic light emitting layer.

ITO (indium tin oxide) is used to form the transparent electrode 12 as an anode for injecting holes into the organic light emitting layer. IZO (indium zinc oxide) is used to form the transparent electrode 14 as a cathode for injecting electrons into the organic light emitting layer.

The structure of the liquid crystal panel 20 is such that a liquid crystal layer 25 is held between two transparent substrates 23 and 24, and polarizing plates 21 and 22 are respectively arranged on the main surfaces of the transparent substrates 23 and 24 facing outwards. However, the liquid crystal panel 20 may be of an alternative structure.

The linear polarization reflector 30 is arranged on the rear surface of the transparent substrate 11 of the organic EL backlight 10, and is formed by a reflector called 3M's DBEF, for example.

The absorber 40 is intended to absorb light having passed through the linear polarization reflector 30. The absorber 40 may be formed by any materials as long as the absorber 40 is capable of absorbing light without generating light reflection. The absorber 40 may be replaced by a black coating on the surface of the linear polarization reflector 30 opposite to the surface facing the organic EL backlight 10.

A-2. Operation

Next, the behavior of light emitted from the organic EL backlight 10 of the liquid crystal display 100 is discussed.

Power supplied from the power supply PW to the organic EL layer 13 generates EL emission, thereby causing emission of light 1 from the organic EL layer 13 to the liquid crystal panel 20 while causing emission of light 2 from the organic EL layer 13 toward the rear surface (opposite to the surface facing the liquid crystal panel 20) of the transparent substrate 11.

The lights 1 and 2 are spontaneously emitted lights, and therefore are subjected to no deviation of polarization. The lights 1 and 2 each contain two linearly polarized light components orthogonal to each other in the same ratio.

Light 2e as one linearly polarized light component of the light 2 passes through the linear polarization reflector 30, and is thereafter absorbed by the absorber 40. Light 2a as the other linearly polarized light component of the light 2 is reflected by the linear polarization reflector 30, and thereafter returns to the organic EL layer 13.

The light 2a having returned to the organic EL layer 13 generates stimulated emission in the organic EL layer 13. Then amplified light 2b (stimulated light) having the same travel direction and polarization direction as the light 2a while having higher intensity than the light 2a is generated. The amplified light 2b is emitted as amplified light 2c from the organic EL layer 13.

Thus light can be limited to the polarization component entering the liquid crystal panel 20 by the use of the linear polarization reflector 30. As a result, the amount of light entering the liquid crystal panel 20 is increased to thereby realize a high-brightness liquid crystal display.

The lights 1 and 2c having entered the liquid crystal panel 20 pass through the liquid crystal layer 25 to be changed in polarization direction, whereby the lights 1 and 2c are respectively emitted as lights 1a and 2d from the polarizing plate 22.

Again, the organic EL layer 13 contains an organic EL material for generating emission of phosphorescence. Thus stimulated emission can be generated with a high degree of efficiency.

More particularly, this organic EL material generates emission of phosphorescence with an emission lifetime of 100 nsec to 1 msec. This serves to suppress deterioration of the organic EL material as well as to generate stimulated emission with a high degree of efficiency.

In order to generate stimulated emission, photons should meet molecules of the organic EL material in an excited state. Photons and molecules hardly meet under a short emission lifetime (period of recombination) to generate substantially no stimulated emission. As an example, fluorescence has an emission lifetime of about 1 nsec to generate substantially no stimulated emission. In contrast, the organic EL material can be in an excited state for a long period of time with a long emission lifetime of phosphorescence such as 1 msec or longer. Thus reaction with oxygen or water may be caused with a higher probability, resulting in deterioration of the organic EL material.

Power supplied to the organic EL layer 13 generates the spontaneously emitted lights 1 and 2 while contributing to the generation of the stimulated light 2b.

The amounts of light generated by the same amount of power are constant. Thus the amounts of the spontaneously emitted lights 1 and 2 are reduced as compared to the case in which no stimulated light 2b is generated. However, the travel direction of the stimulated light 2b is substantially perpendicular to the main surface of the organic EL layer 13, whereby the amount of light 2c entering the liquid crystal panel 20 is larger than the reduced amounts of the spontaneously emitted lights 1 and 2. Further, the linear polarization reflector 30 is arranged so that the polarization direction of the light 2c coincides with the transmission axis of the polarizing plate 21 on the light receiving side of the liquid crystal panel 20. The light 2c is thereby allowed to enter the liquid crystal panel 20 with a high degree of efficiency to increase the brightness level of the liquid crystal display 100.

If the organic EL layer 13 does not contain an organic EL material for generating emission of phosphorescence so stimulated emission is unlikely to occur, no amplification by the stimulated emission can be expected to simply collect the light 2a of one linearly polarized light component of the spontaneously emitted light 2. In this case, only 50% of all the light emitted from the organic EL layer 13 and entering the liquid crystal panel 20 ideally coincides in polarization direction with the transmission axis of the polarizing plate 21.

In contrast, in the liquid crystal display 100 containing an organic EL material for generating emission of phosphorescence in the organic EL layer 13, part of spontaneously emitted light is amplified and converted by stimulated emission into stimulated light. Thus 60% of all the light emitted from the organic EL layer 13 and entering the liquid crystal panel 20 ideally coincides in polarization direction with the transmission axis of the polarizing plate 21, whereby the brightness level of the liquid crystal display 100 is increased.

A-3. Modification

In the foregoing description of the organic EL backlight 10, the organic EL layer 13 is provided over the transparent substrate 11. Alternatively, the transparent substrate 11 may be replaced by a stacked structure formed by the linear polarization reflector 30 and the absorber 40.

### B. Second Preferred Embodiment

B-1. Device Structure

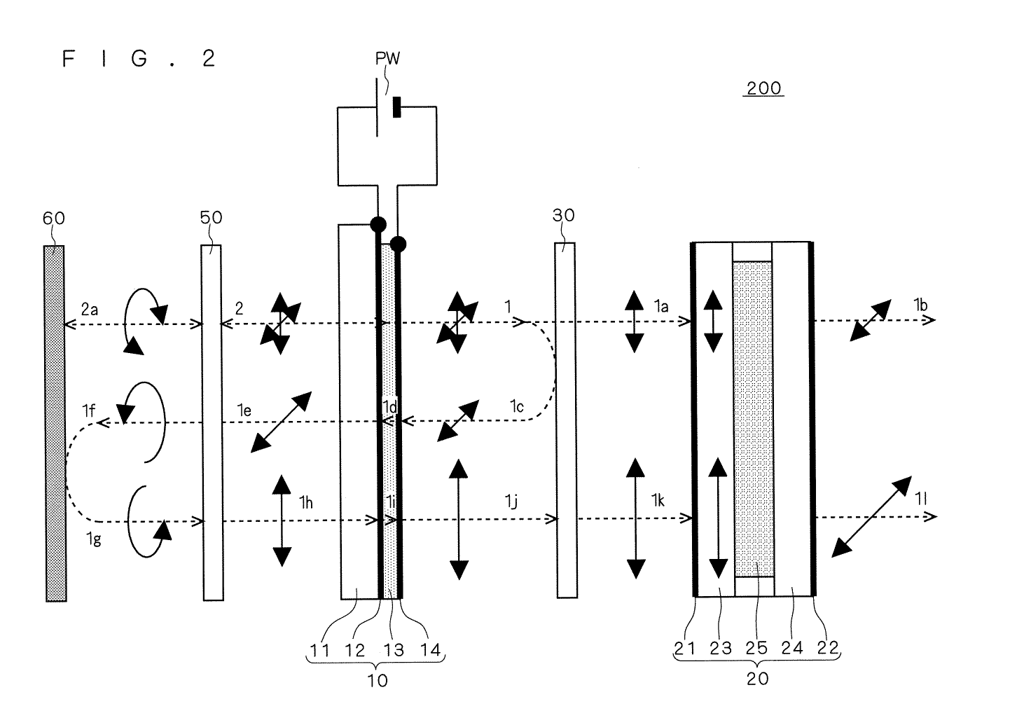

FIG. 2 is a sectional view schematically showing the basic structure of a liquid crystal display 200 according to a second preferred embodiment of the present invention.

With reference to FIG. 2, the liquid crystal display 200 includes the organic EL backlight 10, liquid crystal panel 20, linear polarization reflector 30, a retardation plate (quarter-wave plate) 50 and a reflector 60 spaced in parallel to each other. The particular arrangement is such that the retardation plate 50 is held between the reflector 60 and the organic EL backlight 10, the organic EL backlight 10 is held between the retardation plate 50 and the linear polarization reflector 30, and the linear polarization reflector 30 is held between the organic EL backlight 10 and the liquid crystal panel 20. The same structures as those of the liquid crystal display 100 shown in FIG. 1 are designated by the same reference numerals, and will not be discussed in detail.

B-2. Operation

Next, the behavior of light emitted from the organic EL backlight 10 of the liquid crystal display 200 is discussed.

Power supplied from the power supply PW to the organic EL layer 13 generates EL emission, thereby causing emission of light 1 from the organic EL layer 13 to the liquid crystal panel 20 while causing emission of light 2 from the organic EL layer 13 toward the rear surface of the transparent substrate 11.

Light 1a which is one linearly polarized light component of the light 1 emitted from the organic EL layer 13 to the liquid crystal panel 20 while coinciding with the transmission axis of the linear polarization reflector 30 passes through the linear polarization reflector 30, thereafter passing through the polarizing plate 21 on the light receiving side of the liquid crystal panel 20. At this time, the linear polarization reflector 30 should be arranged so that the respective transmission axes of the linear polarization reflector 30 and the polarizing plate 21 coincide with each other.

Light 1c as the other linearly polarized light component of the light 1 is reflected by the linear polarization reflector 30, and thereafter returns to the organic EL layer 13.

The light 1c having returned to the organic EL layer 13 generates stimulated emission in the organic EL layer 13. Then amplified light 1d (stimulated light) having the same travel direction and polarization direction as the light 1c while having higher intensity than the light 1c is generated. The amplified light 1d is emitted as amplified light 1e from the organic EL layer 13.

The light 1e passes through the retardation plate 50 to become light 1f (circularly polarized light) by circular polarization (left-handed or right-handed circular polarization).

The light 1f is reflected by the reflector 60 to become light 1g. Then the light 1g returns to and passes through the retardation plate 50, thereby obtaining linearly polarized light 1h rotated 90 degrees in polarization direction with respect to the light 1e. The light 1h thereafter returns again to the organic EL layer 13.

The light 1h having returned again to the organic EL layer 13 generates stimulated emission in the organic EL layer 13, whereby amplified light 1i is generated that has the same travel direction and polarization direction as the light 1h while having higher intensity than the light 1h. The amplified light 1i is emitted as amplified light 1j from the organic EL layer 13. The light 1j passes through the linear polarization reflector 30 and then enters the liquid crystal panel 20 as light 1k.

As previously discussed, the organic EL layer 13 contains an organic EL material for generating emission of phosphorescence. Thus stimulated emission can be generated with a high degree of efficiency.

The light 2 emitted toward the rear surface of the transparent substrate 11 passes through the retardation plate 50 to become circularly polarized light 2a containing a right-handed circularly polarized light component and a left-handed circularly polarized light component in the same ratio. The light 2a is reflected by the reflector 60 and returns to the retardation plate 50, thereby obtaining linearly polarized light containing two linearly polarized light components in the same ratio. The light 2a is reflected by the reflector 60 and returns to the retardation plate 50, thereby being rotated 90 degrees in polarization direction. The light 2 is spontaneously emitted light and is hence subjected to no deviation of polarization. Thus the light 2, in other words, is simply reflected by the reflector 60 and then returns to the organic EL layer 13.

The light 2 having returned to the organic EL layer 13 also generates stimulated emission therein. The light 2 is subjected to no deviation of polarization, and thus the behavior of the light 2 is the same as the light 1 emitted to the liquid crystal panel 20.

The lights 1a and 1k passing through the linear polarization reflector 30 coincide in polarization direction as the transmission axis of the polarizing plate 21 on the light receiving side of the liquid crystal panel 20. Thus the lights 1a and 1k enter the liquid crystal panel 20 with a high degree of efficiency. The lights 1a and 1k having entered the liquid crystal panel 20 pass through the liquid crystal layer 25 to be changed in polarization direction, whereby the lights 1a and 1k are respectively emitted as lights 1b and 1l from the polarizing plate 22.

Power supplied to the organic EL layer 13 generates the spontaneously emitted lights 1 and 2 while contributing to the generation of the stimulated lights 1d and 1i.

The amounts of light generated by the same amount of power are constant. Thus the amounts of the spontaneously emitted lights 1 and 2 are reduced as compared to the case in which no stimulated lights 1d and 1i are generated. However, the travel directions of the stimulated lights 1d and 1i are substantially perpendicular to the main surface of the organic EL layer 13, whereby the amount of the light 1k finally entering the liquid crystal panel 20 is larger than the reduced amounts of the spontaneously emitted lights 1 and 2. Further, the transmission axis of the linear polarization reflector 30 is adjusted so that the polarization direction of the light 1k coincides with the transmission axis of the polarizing plate 21 on the light receiving side of the liquid crystal panel 20. The light 1k is thereby allowed to enter the liquid crystal panel 20 with a high degree of efficiency to increase the brightness level of the liquid crystal display 200.

If the organic EL layer 13 does not contain an organic EL material for generating emission of phosphorescence, stimulated emission is unlikely to occur. Even in this case, in the structure similar to the liquid crystal display 200, 100% of light spontaneously emitted from the organic EL layer 13 can be ideally used as light coinciding in polarization direction with the transmission axis of the polarizing plate 21 on the light receiving side of the liquid crystal panel 20 by collecting polarized light.

However, spontaneously emitted light from the organic EL layer 13 has no directivity and travels in every solid direction. Thus light emitted from the organic EL layer 13 at a large output angle with respect to an axis perpendicular to the panel surface of the liquid crystal panel 20 is reflected by each of the linear polarization reflector 30, retardation plate 50 and reflector 60 with high reflectivity. As a result, this spontaneously emitted light does not enter the liquid crystal panel 20 and is lost accordingly.

In the liquid crystal display 200 containing an organic EL material for generating emission of phosphorescence in the organic EL layer 13, light spontaneously emitted from the organic EL layer 13 at a large output angle is also lost. However, light emitted from the organic EL layer 13 at such a small output angle that the light is allowed to return or return again to the organic EL layer 13 is amplified by way of stimulated emission. As a result, the ratio of light of a particular polarization component having an angular component close to an axis perpendicular to the panel surface of the liquid crystal panel 20 is increased. Thus light emitted from the organic EL layer 13 is allowed to enter the liquid crystal panel 20 with small loss.

By using the linear polarization reflector 30, retardation plate 50 and reflector 60, light can be limited to the polarization component entering the liquid crystal panel 20. As a result, the amount of light entering the liquid crystal panel 20 is increased to thereby realize a high-brightness liquid crystal display.

B-3. Modification

In the foregoing description of the organic EL backlight 10, the organic EL layer 13 is provided over the transparent substrate 11. Alternatively, the transparent substrate 11 may be replaced by a stacked structure formed by the retardation plate 50 and the reflector 60.

### C. Third Preferred Embodiment

C-1. Device Structure

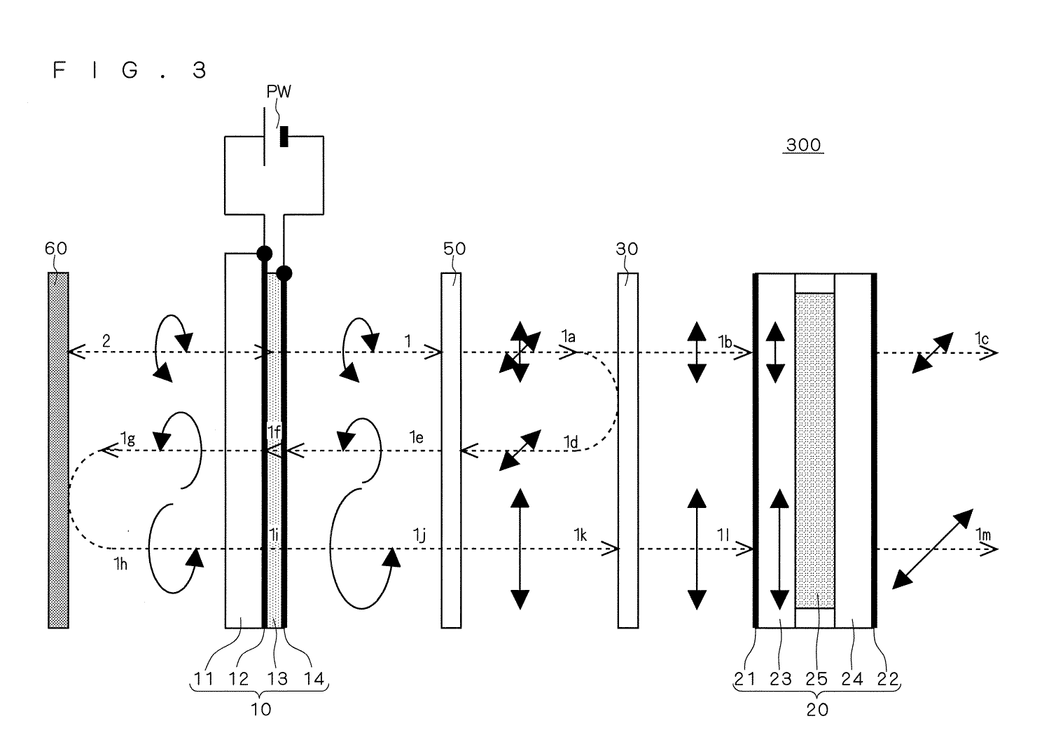

FIG. 3 is a sectional view schematically showing the basic structure of a liquid crystal display 300 according to a third preferred embodiment of the present invention.

With reference to FIG. 3, the liquid crystal display 300 includes the organic EL backlight 10, liquid crystal panel 20, linear polarization reflector 30, retardation plate (quarter-wave plate) 50 and reflector 60 spaced in parallel to each other. The particular arrangement is such that the organic EL backlight 10 is held between the reflector 60 and the retardation plate 50, the retardation plate 50 is held between the organic EL backlight 10 and the linear polarization reflector 30, and the linear polarization reflector 30 is held between the retardation plate 50 and the liquid crystal panel 20. The rear surface of the transparent substrate 11 may be coated with a reflective film containing for example aluminum (Al) or silver (Ag) in place of the reflector 60 spaced apart from the organic EL backlight 10. The same structures as those of the liquid crystal display 100 shown in FIG. 1 are designated by the same reference numerals, and will not be discussed in detail.

C-2. Operation

Next, the behavior of light emitted from the organic EL backlight 10 of the liquid crystal display 300 is discussed.

Power supplied from the power supply PW to the organic EL layer 13 causes emission of light 1 from the organic EL layer 13 to the liquid crystal display 20 while causing emission of light 2 from the organic EL layer 13 toward the rear surface of the transparent substrate 11.

The spontaneously emitted lights 1 and 2 each contain a right-handed circularly polarized light component and a left-handed circularly polarized light component in the same ratio.

The light emitted from the organic EL layer 13 to the liquid crystal panel 20 is converted at the retardation plate 50 into light 1a having two linearly polarized light components orthogonal to each other. At this time, the light 1 passes through the retardation plate 50 to be rotated 90 degrees in polarization direction. The light 1 is spontaneously emitted light and is hence subjected to no deviation of polarization. Thus the light 1, in other words, simply passes through the retardation plate 50.

Light 1b as one of two linearly polarized light components of the light 1a coinciding with the transmission axis of the linear polarization reflector 30 passes through the linear polarization reflector 30.

At this time, the retardation plate 50 and the linear polarization reflector 30 are arranged so that the transmission axis of the polarizing plate 21 on the light receiving side of the liquid crystal panel 20 and the polarization direction of the light 1b coincide with each other. That is, the arrangement of the linear polarization reflector 30 is such that either one of the two linearly polarized light components obtained at the retardation plate 50 passes through the linear polarization reflector 30. Further, the arrangement of the linear polarization reflector 30 and the polarizing plate 21 is such that the respective transmission axes of the linear polarization reflector 30 and the polarizing plate 21 coincide with each other.

Light 1d as the other linearly polarized light component of the light 1a is reflected by the linear polarization reflector 30, converted at the retardation plate 50 into circularly polarized light 1e (containing a right-handed circularly polarized light component and a left-handed circularly polarized light component), and thereafter returns to the organic EL layer 13.

The light 1e having returned to the organic EL layer 13 generates stimulated emission in the organic EL layer 13. Then amplified light 1f (stimulated light) having the same travel direction and polarization direction as the light 1e while having higher intensity than the light 1e is generated. The amplified light 1f passes through the transparent substrate 11, and is emitted as amplified light 1g having the same travel direction and polarization direction as the light 1e. The light 1g is reflected by the reflector 60, and returns again as reflected light 1h to the organic EL layer 13.

The light 1h having returned again to the organic EL layer 13 generates stimulated emission in the organic EL layer 13, whereby amplified light 1i (stimulated light) is generated that has the same travel direction and polarization direction as the light 1h while having higher intensity than the light 1h. The amplified light 1i is emitted as amplified light 1j from the organic EL layer 13 that has the same travel direction and polarization direction as the light 1h.

The light 1j passes through the retardation plate 50 to be converted into amplified light 1k having a linearly polarized light component in one direction and being rotated 90 degrees in polarization direction with respect to the light 1d.

The polarization direction of the amplified light 1k is the same as the direction of the transmission axis of the linear polarization reflector 30, so the light 1k passes through the linear polarization reflector 30 to enter the liquid crystal panel 20 as light 1l.

The lights 1b and 1l passing through the linear polarization reflector 30 coincide in polarization direction with the transmission axis of the polarizing plate 21 on the light receiving side of the liquid crystal panel 20. Thus the lights 1b and 1l enter the liquid crystal panel 20 with a high degree of efficiency. The lights 1b and 1l having entered the liquid crystal panel 20 pass through the liquid crystal layer 25 to be changed in polarization direction, whereby the lights 1b and 1l are respectively emitted as lights 1c and 1m from the polarizing plate 22.

The light 2 emitted toward the rear surface of the transparent substrate 11 is reflected by the reflector 60 to return to the organic EL layer 13. The light 2 having returned to the organic EL layer 13 also generates stimulated emission therein. The light 2 is subjected to no deviation of polarization, and thus the behavior of the light 2 is the same as the light 1 emitted to the liquid crystal panel 20.

Power supplied to the organic EL layer 13 generates the spontaneously emitted lights 1 and 2 while contributing to the generation of the stimulated lights 1f and 1i.

The amounts of light generated by the same amount of power are constant. Thus the amounts of the spontaneously emitted lights 1 and 2 are reduced as compared to the case in which no stimulated lights 1f and 1i are generated. However, the stimulated lights 1f and 1i travel in one direction, whereby the amount of the light 1l finally entering the liquid crystal panel 20 is larger than the reduced amounts of the spontaneously emitted lights 1 and 2. Further, the transmission axis of the linear polarization reflector 30 is adjusted so that the polarization direction of the light 1l coincides with the transmission axis of the polarizing plate 21 on the light receiving side of the liquid crystal panel 20. The light 1l is thereby allowed to enter the liquid crystal panel 20 with a high degree of efficiency to increase the brightness level of the liquid crystal display 300.

If the organic EL layer 13 does not contain an organic EL material for generating emission of phosphorescence, stimulated emission is unlikely to occur. Even in this case, in the structure similar to the liquid crystal display 300, 100% of light spontaneously emitted from the organic EL layer 13 can be ideally used as light coinciding in polarization direction with the transmission axis of the polarizing plate 21 on the light receiving side of the liquid crystal panel 20 by collecting polarized light.

However, spontaneously emitted light from the organic EL layer 13 has no directivity and travels in every solid direction. Thus light emitted from the organic EL layer 13 at a large output angle with respect to an axis perpendicular to the panel surface of the liquid crystal panel 20 is reflected by each of the linear polarization reflector 30, retardation plate 50 and reflector 60 with high reflectivity. As a result, this spontaneously emitted light does not enter the liquid crystal panel 20 and is lost accordingly.

In the liquid crystal display 300 containing an organic EL material for generating emission of phosphorescence in the organic EL layer 13, light spontaneously emitted from the organic EL layer 13 at a large output angle is also lost. However, light emitted from the organic EL layer 13 at such a small output angle that the light is allowed to return or return again to the organic EL layer 13 is amplified by way of stimulated emission. As a result, the ratio of light of a particular polarization component having an angular component close to an axis perpendicular to the panel surface of the liquid crystal panel 20 is increased. Thus light emitted from the organic EL layer 13 is allowed to enter the liquid crystal panel 20 with small loss.

By using the retardation plate 50 and reflector 60, light can be limited to the polarization component entering the liquid crystal panel 20. As a result, the amount of light entering the liquid crystal panel 20 is increased to thereby realize a high-brightness liquid crystal display.

C-3. First Modification

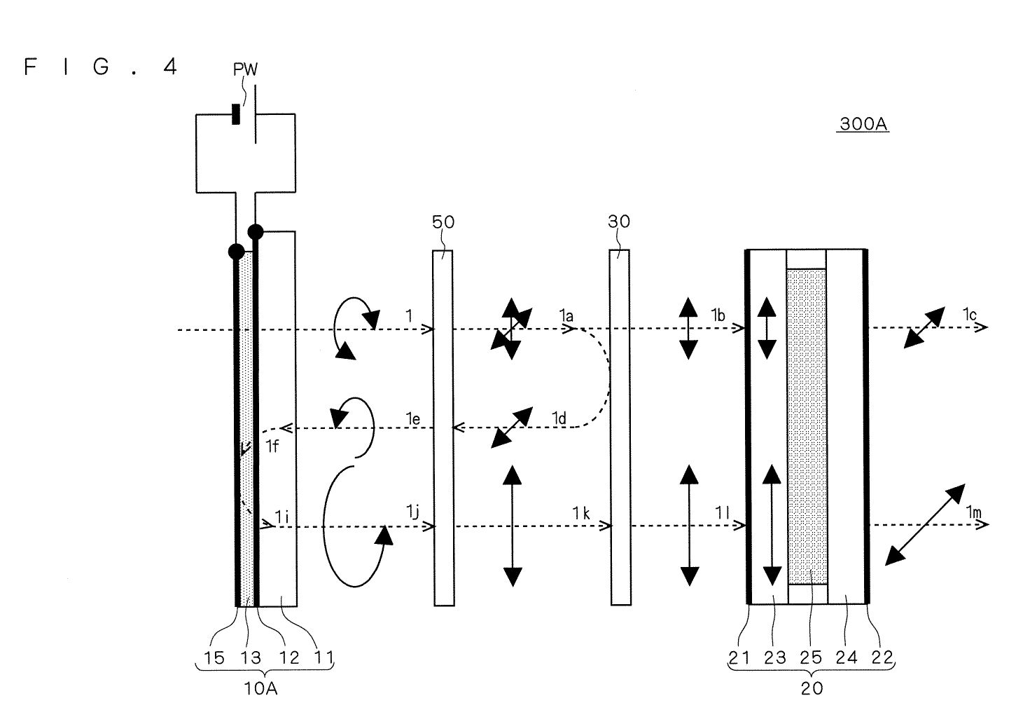

A liquid crystal display 300A shown in FIG. 4 has been made as a first modification of the liquid crystal display 300 according to the above-described third preferred embodiment. The liquid crystal display 300A produces the same effect as the liquid crystal display 300.

In the liquid crystal display 300A shown in FIG. 4, the organic EL backlight 10 of the liquid crystal display 300 shown in FIG. 3 is replaced by an organic EL backlight 10A, and no reflector 60 is provided.

The organic EL backlight 10A has the transparent substrate 11, transparent electrode 12 as an anode formed on the rear surface (surface opposite to the liquid crystal panel 20) of the transparent substrate 11, organic EL layer 13 and a reflective electrode 15 as a cathode stacked in this order. The transparent electrode 12 and the reflective electrode 15 are connected to the power supply PW.

The materials, ingredients and the like of the transparent substrate 11, transparent electrode 12 and organic EL layer 13 are the same as those of the organic EL backlight 10. The reflective electrode 15 serving as a cathode for injecting electrons into an organic light emitting layer contains aluminum. The same structures as those of the liquid crystal display 300 shown in FIG. 4 are designated by the same reference numerals, and will not be discussed in detail.

In the liquid crystal display 300A, the behavior of light emitted from the organic EL backlight 10A is basically the same as light emitted from the organic EL backlight 10 in the liquid crystal display 300. However, as a result of the provision of the reflective electrode 15 on the rear surface (surface opposite to the liquid crystal panel 20) of the organic EL layer 13, light emitted from the organic EL backlight 10A is different in reflection from light emitted from the organic EL backlight 10.

Circularly polarized light 1e emitted from the retardation plate 50 (containing a right-handed circularly polarized light component or a left-handed circularly polarized light component) returns to the organic EL layer 13 to generate stimulated emission in the organic EL layer 13, whereby amplified light 1f (stimulated light) is generated that has the same travel direction and polarization direction as the light 1e while having higher intensity than the light 1e. The light 1f is reflected by the reflective electrode 15 to return again to the organic EL layer 13.

The light 1f having returned again to the organic EL layer 13 generates stimulated emission in the organic EL layer 13, whereby amplified light 1i (stimulated light) is generated that has the same travel direction and polarization direction as the light 1f while having higher intensity than the light 1f. The light 1i passes through the transparent substrate 11 and is then emitted as amplified light 1j.

Light spontaneously emitted from the organic EL layer 13 toward the reflective electrode 15 is reflected by the reflective electrode 15 and then returns to the organic EL layer 13. This light having returned to the organic EL layer 13 also generates stimulated emission therein. This light is subjected to no deviation of polarization. Thus the behavior thereof is the same as light 1 emitted to the liquid crystal panel 20, and is not shown in FIG. 4.

With the simplified structure described above, a downsized liquid crystal display can be provided at low cost.

In the foregoing description, the organic EL backlight 10A has been described as a stacked structure formed by the transparent substrate 11 and the organic EL layer 13. Alternatively, the transparent substrate 11 may be replaced by a stacked structure formed by the retardation plate 50 and the linear polarization reflector 30.

C-4. Second Modification

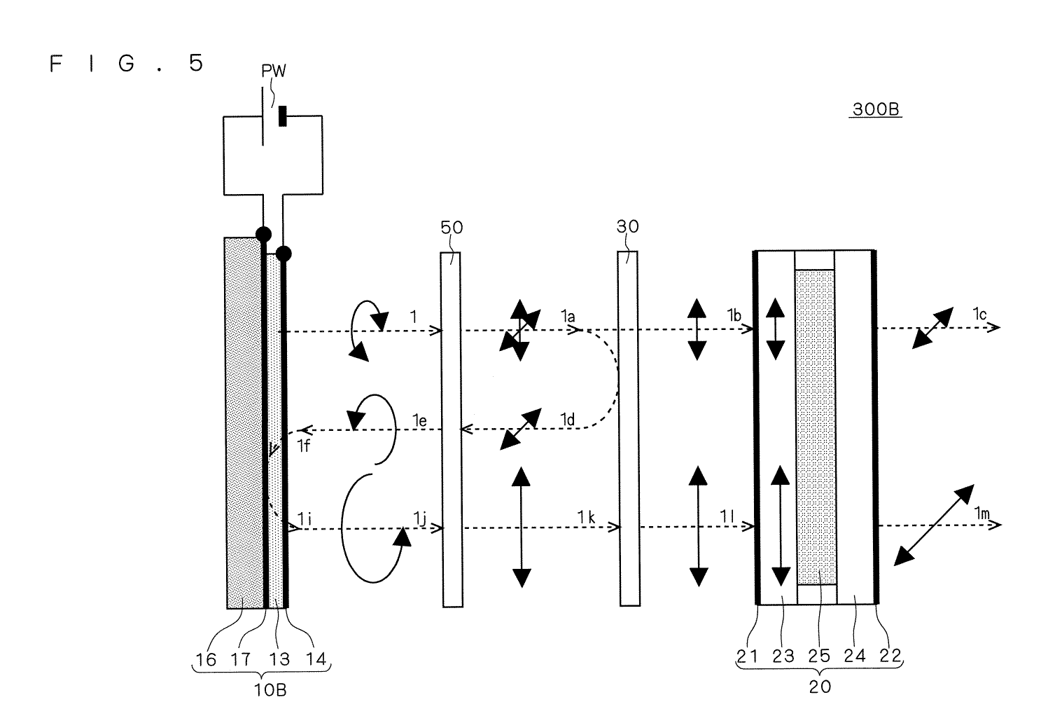

A liquid crystal display 300B shown in FIG. 5 has been made as a second modification of the liquid crystal display 300 according to the above-described third preferred embodiment. The liquid crystal display 300B produces the same effect as the liquid crystal display 300.

In the liquid crystal display 300B shown in FIG. 5, the organic EL backlight 10 of the liquid crystal display 300 shown in FIG. 3 is replaced by an organic EL backlight 10B, and no reflector 60 is provided.

The organic EL backlight 10B has a support substrate 16, a reflective electrode 17 as an anode formed on the front surface (surface facing the liquid crystal panel 20) of the support substrate 16, the organic EL layer 13 and the transparent electrode 14 stacked in this order. The organic EL layer 13 faces the liquid crystal panel 20. The reflective electrode 17 and the transparent electrode 14 are connected to the power supply PW.

The support substrate 16 may be formed by glass, for example. Alternatively, the support substrate 16 may be formed by a resin film or a resin sheet containing polymethyl methacrylate, polycarbonate, polystyrene, styrene acrylonitrile, cycloolefin, alicyclic polyolefin, cyclic polyolefin, alicyclic acrylic, polyester, or the like.

The support substrate 16 is not required to be a transparent or an insulation substance. The support substrate 16 may be formed by a metallic material such as aluminum, copper or stainless. Still alternatively, the support substrate 16 may be formed by a ceramic material such as Al₂O₃, or by an opaque resin such as ABS or polyphenylene ether.

The materials, ingredients and the like of the transparent electrode 14 and the organic EL layer 13 are the same as those of the organic EL backlight 10. The reflective electrode 17 serving as an anode for injecting holes into an organic light emitting layer may be a formed by film in which metal with a high work function such as gold (Au), nickel (Ni), platinum (Pt) or another type of metal such as Al and ITO are stacked.

In the liquid crystal display 300B, the behavior of light emitted from the organic EL backlight 10B is basically the same as light emitted from the organic EL backlight 10 in the liquid crystal display 300. However, as a result of the provision of the reflective electrode 17 on the rear surface (surface opposite to the liquid crystal panel 20) of the organic EL layer 13, light emitted from the organic EL backlight 10B is different in reflection from light emitted from the organic EL backlight 10.

Circularly polarized light 1e emitted from the retardation plate 50 (containing a right-handed circularly polarized light component or a left-handed circularly polarized light component) returns to the organic EL layer 13 to generate stimulated emission in the organic EL layer 13, whereby amplified light 1f (stimulated light) is generated that has the same travel direction and polarization direction as the light 1e while having higher intensity than the light 1e. The light 1f is reflected by the reflective electrode 17 to return again to the organic EL layer 13.

The light 1f having returned again to the organic EL layer 13 generates stimulated emission in the organic EL layer 13, whereby amplified light 1i (stimulated light) is generated that has the same travel direction and polarization direction as the light 1f while having higher intensity than the light 1f. The light 1i passes through the transparent electrode 14 and is then emitted as amplified light 1j.

Light spontaneously emitted from the organic EL layer 13 toward the reflective electrode 17 is reflected by the reflective electrode 17 and then returns to the organic EL layer 13. This light having returned to the organic EL layer 13 also generates stimulated emission therein. This light is subjected to no deviation of polarization. Thus the behavior thereof is the same as light 1 emitted to the liquid crystal panel 20, and is not shown in FIG. 5.

With the simplified structure described above, a downsized liquid crystal display can be provided at low cost.

### D. Fourth Preferred Embodiment

D-1. Device Structure

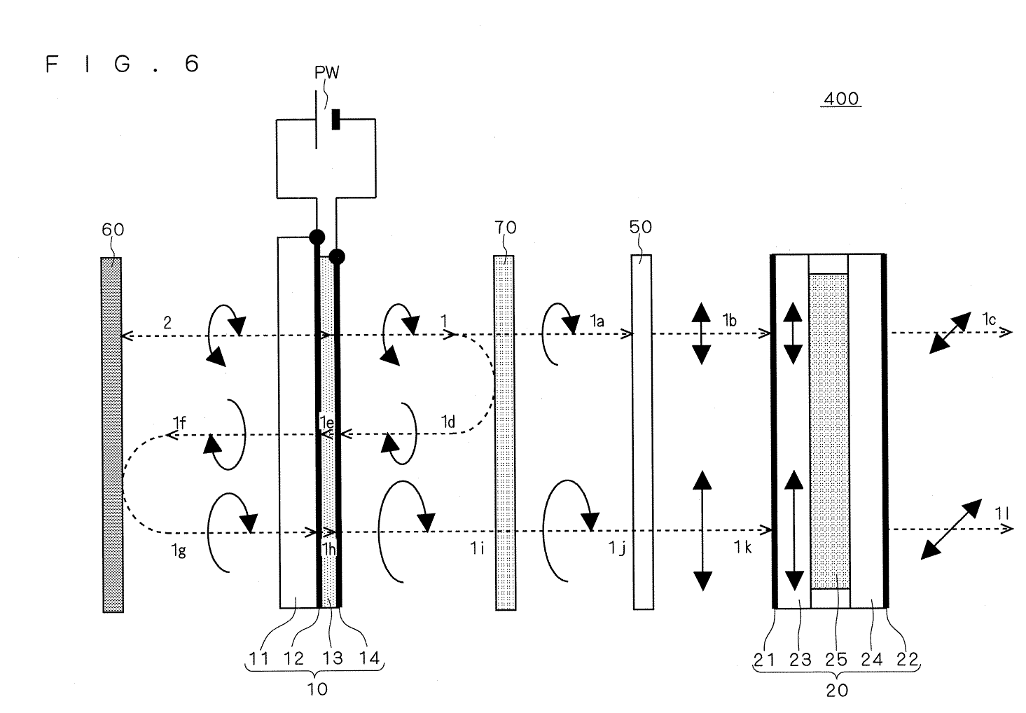

FIG. 6 is a sectional view schematically showing the basic structure of a liquid crystal display 400 according to a fourth preferred embodiment of the present invention.

With reference to FIG. 6, the liquid crystal display 400 includes the organic EL backlight 10, liquid crystal panel 20, retardation plate (quarter-wave plate) 50, reflector 60 and a circular polarization reflector 70 spaced in parallel to each other. The particular arrangement is such that the organic EL backlight 10 is held between the reflector 60 and the circular polarization reflector 70, the circular polarization reflector 70 is held between the organic EL backlight 10 and the retardation plate 50, and the retardation plate 50 is held between the circular polarization reflector 70 and the liquid crystal panel 20.

The circular polarization reflector 70 is formed by a reflector called TRANSMAX by E. Merck & Co., or by a reflector called NIPOCS by NITTO DENKO CORPORATION, for example.

The rear surface of the transparent substrate 11 may be coated with a reflective film containing for example aluminum (Al) or silver (Ag) in place of the reflector 60 spaced apart from the organic EL backlight 10. The same structures as those of the liquid crystal display 100 shown in FIG. 1 are designated by the same reference numerals, and will not be discussed in detail.

D-2. Operation

Next, the behavior of light emitted from the organic EL backlight 10 of the liquid crystal display 400 is discussed.

Power supplied from the power supply PW to the organic EL layer 13 causes emission of light 1 from the organic EL layer 13 to the liquid crystal display 20 while causing emission of light 2 from the organic EL layer 13 toward the rear surface of the transparent substrate 11.

The spontaneously emitted lights 1 and 2 each contain a right-handed circularly polarized light component and a left-handed circularly polarized light component in the same ratio.

Light 1 a as one of the circularly polarized light components of the light 1 passes through the circular polarization reflector 70, thereafter being converted at the retardation plate 50 into light 1b with one linearly polarized light component, and then enters the liquid crystal panel 20.

At this time, the retardation plate 50 is arranged so that the light 1a having passed through the circular polarization reflector 70 is allowed to pass through the retardation plate 50 to be converted into the light 1b with a polarization direction coinciding with the transmission axis of the polarizing plate 21.

Light 1d as the other circularly polarized light component of the light 1 is reflected by the circular polarization reflector 70, and then returns to the organic EL layer 13.

The light 1d having returned to the organic EL layer 13 generates stimulated emission in the organic EL layer 13. Then amplified light 1e (stimulated light) is generated that has the same travel direction and circular polarization direction as the light 1d while having higher intensity than the light 1d. The light 1e is emitted as light 1f from the transparent substrate 11.

The light 1f is reflected by the reflector 60 to become light 1g, and thereafter returns again to the organic EL layer 13.

The reflected light 1g having returned again to the organic EL layer 13 generates stimulated emission in the organic EL layer 13, whereby amplified light 1h (stimulated light) is generated that has the same travel direction and polarization direction as the light 1g while having higher intensity than the light 1g. The light 1h is emitted as amplified light 1i from the organic EL layer 13.

The amplified light 1i has the same circular polarization direction as the light 1a having passed through the circular polarization reflector 70. The amplified light 1i passes through the circular polarization reflector 70 to bceome light 1j.

The light 1j passes through the retardation plate 50 to be converted into amplified light 1k coinciding in polarization direction with the transmission axis of the polarizing plate 21.

The lights 1b and 1k each having one linearly polarized light component obtained at the retardation plate 50 coincide in polarization direction with the transmission axis of the polarizing plate 21 on the light receiving side of the liquid crystal panel 20. Thus the lights 1b and 1k enter the liquid crystal panel 20 with a high degree of efficiency. The lights 1b and 1k having entered the liquid crystal panel 20 pass through the liquid crystal layer 25 to be changed in polarization direction, whereby the lights 1b and 1k are respectively emitted as lights 1c and 1l from the polarizing plate 22.

The light 2 emitted toward the rear surface of the transparent substrate 11 is reflected by the reflector 60 to return to the organic EL layer 13. The light 2 having returned to the organic EL layer 13 also generates stimulated emission therein. The light 2 is subjected to no deviation of polarization, and thus the behavior of the light 2 is the same as the light 1 emitted to the liquid crystal panel 20.

Power supplied to the organic EL layer 13 generates the spontaneously emitted lights 1 and 2 while contributing to the generation of the stimulated lights 1e and 1h.

The amounts of light generated by the same amount of power are constant. Thus the amounts of the spontaneously emitted lights 1 and 2 are reduced as compared to the case in which no stimulated lights 1e and 1h are generated. However, the stimulated lights 1e and 1h travel in one direction, whereby the amount of the light 1k finally entering the liquid crystal panel 20 is larger than the reduced amounts of the spontaneously emitted lights 1 and 2. Further, the transmission axis of the retardation plate 50 is adjusted so that the polarization direction of the light 1k coincides with the transmission axis of the polarizing plate 21 on the light receiving side of the liquid crystal panel 20. The light 1k is thereby allowed to enter the liquid crystal panel 20 with a high degree of efficiency to increase the brightness level of the liquid crystal display 400.

If the organic EL layer 13 does not contain an organic EL material for generating emission of phosphorescence, stimulated emission is unlikely to occur. Even in this case, in the structure similar to the liquid crystal display 400, 100% of light spontaneously emitted from the organic EL layer 13 can be ideally used as light coinciding in polarization direction with the transmission axis of the polarizing plate 21 on the light receiving side of the liquid crystal panel 20 by collecting polarized light.

However, spontaneously emitted light from the organic EL layer 13 has no directivity and travels in every solid direction. Thus light emitted from the organic EL layer 13 at a large output angle with respect to an axis perpendicular to the panel surface of the liquid crystal panel 20 is reflected by each of the retardation plate 50, reflector 60 and circular polarization reflector 70 with high reflectivity. As a result, this spontaneously emitted light does not enter the liquid crystal panel 20 and is lost accordingly.

In the liquid crystal display 400 containing an organic EL material for generating emission of phosphorescence in the organic EL layer 13, light spontaneously emitted from the organic EL layer 13 at a large output angle is also lost. However, light emitted from the organic EL layer 13 at such a small output angle that the light is allowed to return or return again to the organic EL layer 13 is amplified by way of stimulated emission. As a result, the ratio of light of a particular polarization component having an angular component close to an axis perpendicular to the panel surface of the liquid crystal panel 20 is increased. Thus light emitted from the organic EL layer 13 is allowed to enter the liquid crystal panel 20 with small loss.

By using the retardation plate 50 and the circular polarization reflector 70, light can be limited to the polarization component entering the liquid crystal panel 20. As a result, the amount of light entering the liquid crystal panel 20 is increased to thereby realize a high-brightness liquid crystal display.

D-3. First Modification

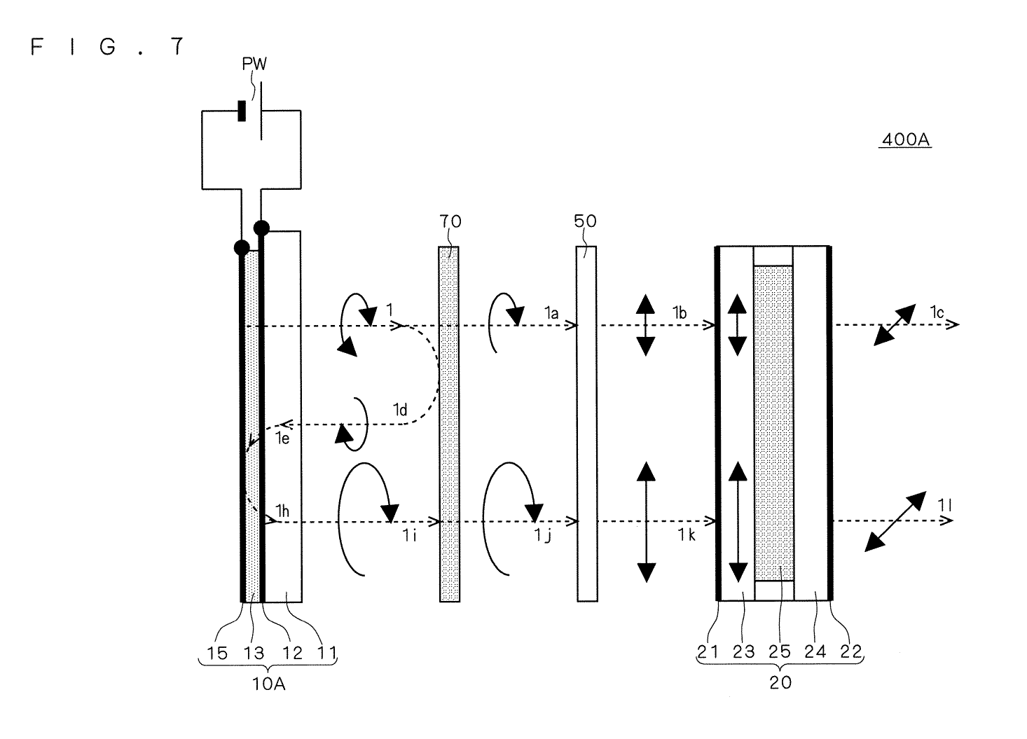

A liquid crystal display 400A shown in FIG. 7 has been made as a first modification of the liquid crystal display 400 according to the above-described fourth preferred embodiment. The liquid crystal display 400A produces the same effect as the liquid crystal display 400.

In the liquid crystal display 400A shown in FIG. 7, the organic EL backlight 10 of the liquid crystal display 400 shown in FIG. 6 is replaced by an organic EL backlight 10A, and no reflector 60 is provided.

The organic EL backlight 10A has the transparent substrate 11, transparent electrode 12 as an anode formed on the rear surface (surface opposite to the liquid crystal panel 20) of the transparent substrate 11, organic EL layer 13 and a reflective electrode 15 as a cathode stacked in this order. The transparent electrode 12 and the reflective electrode 15 are connected to the power supply PW.

The materials, ingredients and the like of the transparent substrate 11, transparent electrode 12 and the organic EL layer 13 are the same as those of the organic EL backlight 10. The reflective electrode 15 serving as a cathode for injecting electrons into an organic light emitting layer contains aluminum. The same structures as those of the liquid crystal display 400 shown in FIG. 6 are designated by the same reference numerals, and will not be discussed in detail.

In the liquid crystal display 400A, the behavior of light emitted from the organic EL backlight 10A is basically the same as light emitted from the organic EL backlight 10 in the liquid crystal display 400. However, as a result of the provision of the reflective electrode 15 on the rear surface (surface opposite to the liquid crystal panel 20) of the organic EL layer 13, light emitted from the organic EL backlight 10A is different in reflection from light emitted from the organic EL backlight 10.

Circularly polarized light 1d emitted from the circular polarization reflector 70 (containing a right-handed circularly polarized light component or a left-handed circularly polarized light component) returns to the organic EL layer 13 to generate stimulated emission in the organic EL layer 13, whereby amplified light 1e (stimulated light) is generated that has the same travel direction and polarization direction as the light 1d while having higher intensity than the light 1d. The light 1e is reflected by the reflective electrode 15 to return again to the organic EL layer 13.

The light 1e having returned again to the organic EL layer 13 generates stimulated emission in the organic EL layer 13, whereby amplified light 1h (stimulated light) is generated that has the same travel direction and polarization direction as the light 1e while having higher intensity than the light 1e. The light 1h passes through the transparent substrate 11 and is then emitted as amplified light 1i.

Light spontaneously emitted from the organic EL layer 13 toward the reflective electrode 15 is reflected by the reflective electrode 15 and then returns to the organic EL layer 13. This light having returned to the organic EL layer 13 also generates stimulated emission therein. This light is subjected to no deviation of polarization. Thus the behavior thereof is the same as light 1 emitted to the liquid crystal panel 20, and is not shown in FIG. 7.

With the simplified structure described above, a downsized liquid crystal display can be provided at low cost.

In the foregoing description, the organic EL backlight 10A has been described as a stacked structure formed by the transparent substrate 11 and the organic EL layer 13. Alternatively, the transparent substrate 11 may be replaced by a stacked structure formed by the circular polarization reflector 70 and the retardation plate 50.

D-4. Second Modification

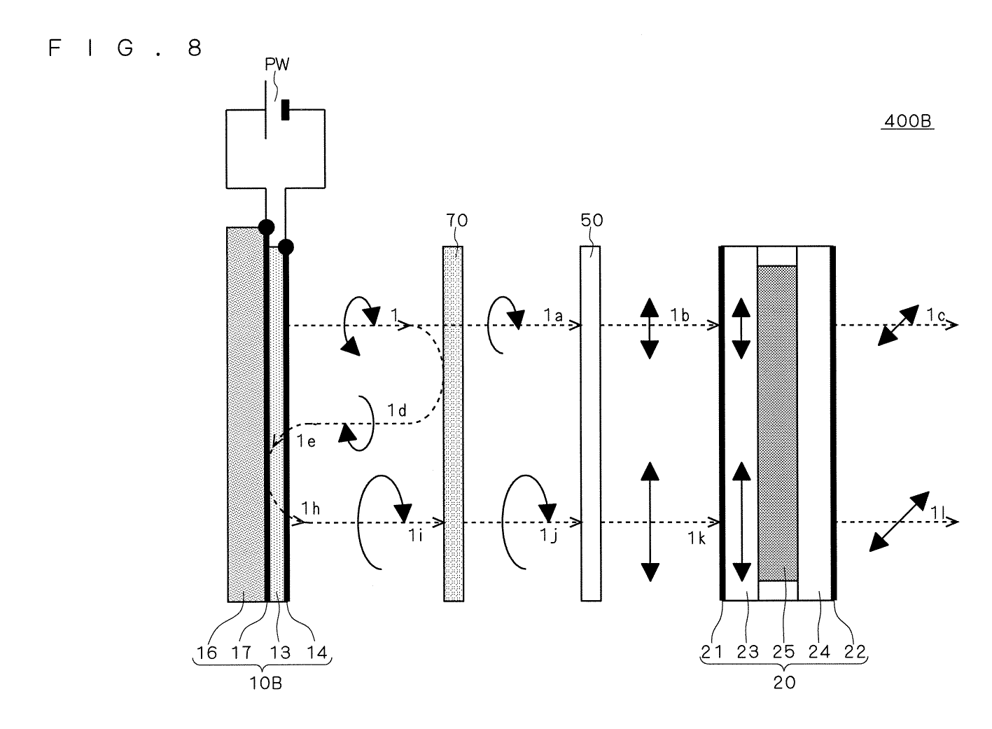

A liquid crystal display 400B shown in FIG. 8 has been made as a second modification of the liquid crystal display 400 according to the above-described third preferred embodiment. The liquid crystal display 400B produces the same effect as the liquid crystal display 400.

In the liquid crystal display 400B shown in FIG. 8, the organic EL backlight 10 of the liquid crystal display 400 shown in FIG. 6 is replaced by an organic EL backlight 10B, and no reflector 60 is provided.

The organic EL backlight 10B has a support substrate 16, a reflective electrode 17 as an anode formed on the front surface (surface facing the liquid crystal panel 20) of the support substrate 16, the organic EL layer 13 and the transparent electrode 14 stacked in this order. The reflective electrode 17 and the transparent electrode 14 are connected to the power supply PW.

The support substrate 16 may be formed by glass, for example. Alternatively, the support substrate 16 may be formed by a resin film or a resin sheet containing polymethyl methacrylate, polycarbonate, polystyrene, styrene acrylonitrile, cycloolefin, alicyclic polyolefin, cyclic polyolefin, alicyclic acrylic, polyester, or the like.

The support substrate 16 is not required to be a transparent or an insulation substance. The support substrate 16 may be formed by a metallic material such as aluminum, copper or stainless. Still alternatively, the support substrate 16 may be formed by a ceramic material such as Al₂O₃, or by an opaque resin such as ABS or polyphenylene ether.

The materials, ingredients and the like of the transparent electrode 14 and the organic EL layer 13 are the same as those of the organic EL backlight 10. The reflective electrode 17 serving as an anode for injecting holes into an organic light emitting layer may be a film in which metal with a high work function such as gold (Au), nickel (Ni), platinum (Pt) or another type of metal such as Al and ITO are stacked.

In the liquid crystal display 400B, the behavior of light emitted from the organic EL backlight 10B is basically the same as light emitted from the organic EL backlight 10 in the liquid crystal display 400. However, as a result of the provision of the reflective electrode 17 on the rear surface (surface opposite to the liquid crystal panel 20) of the organic EL layer 13, light emitted from the organic EL backlight 10B is different in reflection from light emitted from the organic EL backlight 10.

Circularly polarized light 1d emitted from the circular polarization reflector 70 (containing a right-handed circularly polarized light component or a left-handed circularly polarized light component) returns to the organic EL layer 13 to generate stimulated emission in the organic EL layer 13, whereby amplified light 1e (stimulated light) is generated that has the same travel direction and polarization direction as the light 1d while having higher intensity than the light 1d. The light 1e is reflected by the reflective electrode 17 to return again to the organic EL layer 13.

The light 1e having returned again to the organic EL layer 13 generates stimulated emission in the organic EL layer 13, whereby amplified light 1h (stimulated light) is generated that has the same travel direction and polarization direction as the light 1e while having higher intensity than the light 1e. The light 1h passes through the transparent electrode 14 and is then emitted as amplified light 1i.

Light spontaneously emitted from the organic EL layer 13 toward the reflective electrode 17 is reflected by the reflective electrode 17 and then returns to the organic EL layer 13. This light having returned to the organic EL layer 13 also generates stimulated emission therein. This light is subjected to no deviation of polarization. Thus the behavior thereof is the same as light 1 emitted to the liquid crystal panel 20, and is not shown in FIG. 8.

With the simplified structure described above, a downsized liquid crystal display can be provided at low cost.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display, comprising:
an EL backlight having an EL layer for generating EL (electroluminescence) emission;
a liquid crystal panel arranged on the side of a front surface of said EL backlight; and
a polarization reflector arranged on the side of said front surface or a rear surface of said EL backlight, said polarization reflector selectively reflecting light as one of two polarized light components of light generated at said EL backlight to allow said light as one of said two polarized light components to return to said EL backlight, wherein
said EL layer contains an EL material for generating emission of phosphorescence with an emission lifetime of 100 nsec to 1 msec.

2. The liquid crystal display according to claim 1, wherein
said EL material contains a material selected from FIr (pic), Ir (ppy)₃ and Btp₂Ir (acac), and
a host material and said material for said EL material respectively make up 80 to 99.5 percent by mass and 0.5 to 20 percent by mass.

3. The liquid crystal display according to claim 1, wherein said polarization reflector is arranged on the side of said rear surface of said EL backlight,
said liquid crystal display further comprising an absorber so arranged that said absorber faces a surface of said polarization reflector opposite to a surface of said polarization reflector facing said EL backlight, said absorber absorbing light of a polarized light component passing through said polarization reflector.

4. The liquid crystal display according to claim 1, wherein said polarization reflector is a linear polarization reflector arranged between said EL backlight and said liquid crystal panel,
said liquid crystal display further comprising:
a quarter-wave plate arranged on the side of said rear surface of said EL backlight; and
a reflector so arranged that said reflector faces a surface of said quarter-wave plate opposite to a surface of said quarter-wave plate facing said EL backlight, said reflector reflecting light passing through said quarter-wave plate.

5. The liquid crystal display according to claim 1, wherein said polarization reflector is a linear polarization reflector arranged between said EL backlight and said liquid crystal panel,
said liquid crystal display further comprising:
a quarter-wave plate arranged between said EL backlight and said linear polarization reflector; and
a reflector arranged on the side of said rear surface of said EL backlight, said reflector reflecting light emitted from said EL backlight.

6. The liquid crystal display according to claim 1, wherein said polarization reflector is a linear polarization reflector arranged between said EL backlight and said liquid crystal panel,
said liquid crystal display further comprising a quarter-wave plate arranged between said EL backlight and said linear polarization reflector,
said EL backlight having a transparent substrate, and an anode and a cathode arranged on said transparent substrate, said anode and said cathode holding said EL layer therebetween,
said anode being arranged on a surface of said transparent substrate opposite to a surface of said transparent substrate facing said liquid crystal panel, and
said cathode further serving as a reflector for reflecting light emitted from said EL layer.

7. The liquid crystal display according to claim 1, wherein said polarization reflector is a linear polarization reflector arranged between said EL backlight and said liquid crystal panel,
said liquid crystal display further comprising a quarter-wave plate arranged between said EL backlight and said linear polarization reflector,
said EL backlight having a support substrate, and an anode and a cathode arranged on said support substrate, said anode and said cathode holding said EL layer therebetween,
said anode being arranged on a surface of said support substrate facing said liquid crystal panel, and
said anode further serving as a reflector for reflecting light emitted from said EL layer.

8. The liquid crystal display according to claim 1, wherein said polarization reflector is a circular polarization reflector arranged between said EL backlight and said liquid crystal panel,
said liquid crystal display further comprising:
a quarter-wave plate arranged between said circular polarization reflector and said liquid crystal panel; and
a reflector arranged on the side of said rear surface of said EL backlight, said reflector reflecting light emitted from said EL backlight.

9. The liquid crystal display according to claim 1, wherein said polarization reflector is a circular polarization reflector arranged between said EL backlight and said liquid crystal panel,
said liquid crystal display further comprising a quarter-wave plate arranged between said circular polarization reflector and said liquid crystal panel,
said EL backlight having a transparent substrate, and an anode and a cathode arranged on said transparent substrate, said anode and said cathode holding said EL layer therebetween,
said anode being arranged on a surface of said transparent substrate opposite to a surface of said transparent substrate facing said liquid crystal panel, and
said cathode further serving as a reflector for reflecting light emitted from said EL layer.

10. The liquid crystal display according to claim 1, wherein said polarization reflector is a circular polarization reflector arranged between said EL backlight and said liquid crystal panel,
said liquid crystal display further comprising a quarter-wave plate arranged between said circular polarization reflector and said liquid crystal panel,
said EL backlight having a support substrate, and an anode and a cathode arranged on said support substrate, said anode and said cathode holding said EL layer therebetween,
said anode being arranged on a surface of said support substrate facing said liquid crystal panel, and
said anode further serving as a reflector for reflecting light emitted from said EL layer.
